(19) United States
(12) Patent Application Publication
(10) Pub. No.: US 2020/0130019 A1
(43) Pub. Date: Apr. 30, 2020

(54) DEVICE FOR REMOVING MATERIAL FROM A BASE

(71) Applicant: WashTec Holding GmbH, Augsburg (DE)

(72) Inventor: PETER PLÖCKL, Dasing/Rieden (DE)

(21) Appl. No.: 16/620,174

(22) PCT Filed: Jun. 5, 2018
(86) PCT No.: PCT/EP2018/064698

§ 371 Date: Dec. 6, 2019

(30) Foreign Application Priority Data
Jun. 8, 2017 (DE) 10 2017 209 704.3

(51) Int. Cl. B08B 1/00; B08B 1/04

(52) U.S. Cl. CPC B08B 1/005; B08B 1/04

(57) ABSTRACT

A device for partially removing the coating of a metal plate includes a die and a punch which together form a gap through which the metal plate is fed. The device also includes a drive for generating a movement of the die and the punch relative to the metal plate. The die has a protruding blade on the its surface facing the metal plate. A cutting edge of the blade extends in a direction opposite to the movement direction of the metal plate. The device further includes a pressing device for pressing together the die and the punch. The punch includes a roller which rolls on the metal plate surface opposite the blade.

### CROSS REFERENCE TO RELATED APPLICATIONS

This application is the United States national phase entry of International Application No. PCT/EP2018/064698, filed Jun. 5, 2018, which claims the benefit of priority of German Application No. 10 2017 209 704.3, filed Jun. 8, 2017. The contents of International Application No. PCT/EP2018/064698 and German Application No. 10 2017 209 704.3 are incorporated by reference herein in their entireties.

### FIELD

The invention relates to a device for removing a material layer from a base. This in particular concerns the removal of a coating from a metal plate. The coating may consist of zinc, in particular of a strip galvanizing.

### BACKGROUND

Removing is used, for example, when a zinc-coated metal plate is further processed and the zinc layer is interfering with further processing. This is considered if the metal plate is to be welded to other objects, such as another metal plate.

DE 103 03 063 A1 describes a method of removing material, in particular metal, by a laser beam which is introduced into the material to be removed so that it evaporates. This method, however, involves a considerable amount of technical expenditure. It also generates toxic vapors.

The invention is based on the object of providing a device for removing the zinc coating from a zinc-coated metal plate on the planar areas. The device is intended to be simple and inexpensive to manufacture. It is to be possible to remove the coating on surfaces of any desired size. The removal surface may have any contours, e.g. the shape of straight or curved stripes, circular surfaces or angular surfaces, etc.

### SUMMARY

This object is solved by means of a device as described herein.

Such a device comprises the following features:
A die as well as a punch through which the coated metal plate is fed.
A drive to generate a relative movement between the die and punch on the one hand as well as the metal plate on the other hand.
The die has a projecting blade on its side facing the metal plate, a cutting edge of said blade extending in a direction opposite to the movement direction of the metal plate.
A pressing device for pressing the die and the punch together.
The punch carries a roller, which rolls on the surface of the metal plate opposite the blade.

Depending on the width of the blade, a strip of the coating can be removed from the metal plate with this device. The removal depth lies in the range of a few micrometers up to 1 mm or more. The strip can be straight or curved. Even a larger continuous area can be removed by processing adjacent strips. An object can be welded on in the coating-free area. By removing the coating, in particular a zinc coating, welding processes can be carried out without problems. The mechanical removal of coatings according to the invention has proven to be very economic. The removal of coatings by means of laser beams is no longer necessary and thus the associated disadvantages such as the generation of toxic vapors are also eliminated.

The invention can be applied in various fields of industrial production, especially in the serial production of car bodies, in the manufacture of car washes and other applications.

### BRIEF DESCRIPTION OF THE DRAWING FIGURES

The invention is explained in more detail based on the drawings.

The following is shown in detail:

FIG. 1 shows a device in operation, with a metal plate running between die and punch, in front view and in schematic view.

FIG. 2 shows the die according to FIG. 1 in a plan view.

FIG. 3 shows a second embodiment of a die in front view.

FIG. 4 shows a third embodiment of a die.

### DETAILED DESCRIPTION

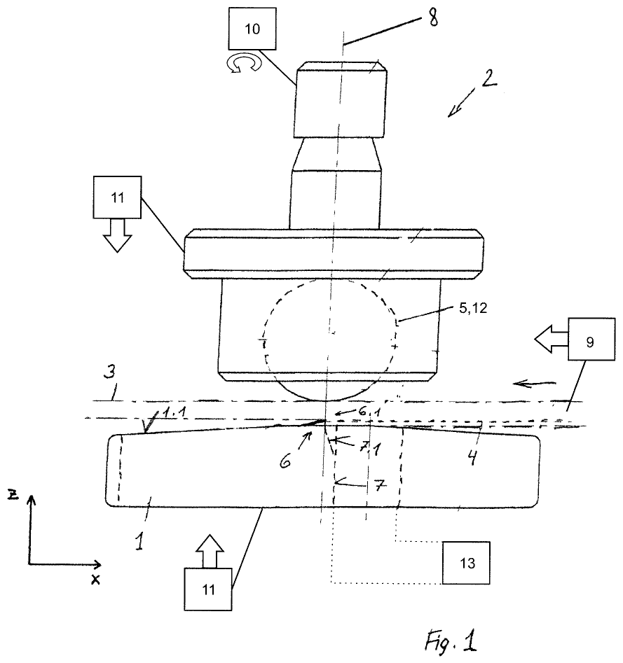

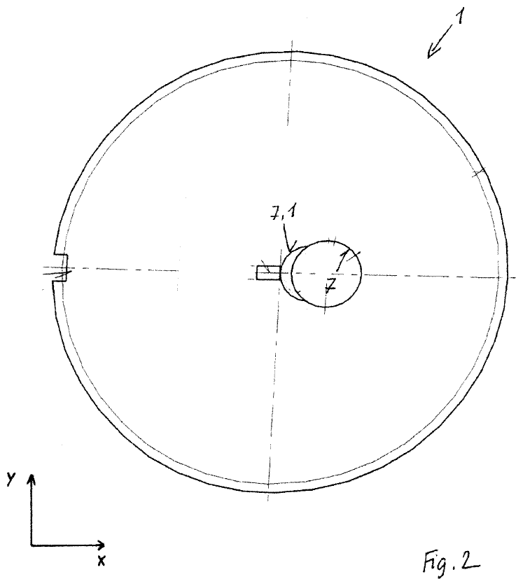

FIGS. 1 and 2 show the following in detail:

Die 1 and punch 2 are arranged at a certain distance from each other so that there is a gap between them. A sheet metal plate 3 is fed through the gap. A drive 9 is provided for generating a relative movement between the die 1 and the punch 2 on the one hand as well as the metal plate 3 on the other hand. The sheet metal plate 3 is provided with a coating 4 on its side facing the die. The coating is a strip galvanizing. The galvanization protects the sheet metal plate 3 against corrosion of the base material over longer periods of time.

The punch 2 carries a rotatably mounted roller 5. The roller 5 is advantageously made of a flexible material such as hard rubber. The entire punch 2 can also be rotatable about its rotation axis 8. A rotary drive 10 is provided for rotating the die 1 and the punch 2. It can also be pivotable about a pivot axis extending parallel to the center of rotation of the roller.

In the present case, the die 1 and the punch 2 are stationary. Instead, the sheet metal plate 3 in FIG. 1 is moved from right to left—see arrow. The roller 5 rolls on the upper side of the sheet metal plate 3. The roller 5 is elastically supported or consists of an elastic material such as hard rubber 12.

An apparatus is used to press the punch 2 against the die 1. A pressing device 11 is provided for pressing together the die 1 and the punch 2.

As can be seen in FIG. 1, the upper surface 1.1 of the die 1 facing the sheet metal plate 3 is cambered, i.e. it is convexly curved. This increases the surface pressure.

On the upper surface 1.1 of the die 1 there is a blade 6. The cutting edge 6.1 of the blade 6 is opposite to the direction of movement of the sheet metal plate 3. If the sheet metal plate 3 moves, as described above, from right to left, a strip of material equal to the width of the blade is removed from the coating 4.

The following is to be noted: the sheet metal plate 3 can move in the x direction as well as in the y direction or in an intermediate direction between these two directions. The die 1 and the punch 2 are rotated around their common rotation axis depending on the direction of movement of the sheet metal plate 3, in order to align the cutting edge 6.1 always against the direction of movement of the sheet metal plate. A straight, coating-free strip is created by even movement in one or both directions—depending on the direction of the motion of the sheet metal plate 3. By combining two independent translational movements and a rotational movement of die and punch, any configuration of coating-free surfaces can be created.

As can be seen from FIGS. 1 and 2, the die 1 has a bore 7. It is a through-hole that passes through the die 1 from its upper to its lower border surface. The bore serves to discharge the chip-like waste which accumulates at the blade 6. The bore 7 can be funnel-shaped in its inlet area, thus having an inlet cross section which tapers in the discharge direction of the chips. See contour 7.1 of the bore 7.

It is also possible to provide a blower device—not shown here—instead of or in addition to the bore 7. A blower device can prevent chips from accumulating in the space between the blade 6 and the upper surface 1.1 of the die 1.

As can be seen in FIGS. 1 and 2, the cutting edge 6.1 of the blade 6 is located at the vertex of the convexly curved upper surface 1.1 of the die 1.

In general, a suction mechanism will be connected to the bore 7, which removes the chips reliably. A chip discharge device 13 is connected to the outlet of the bore 7.

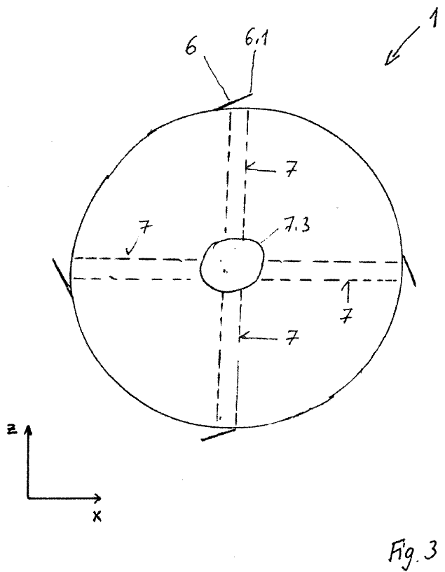

An interesting embodiment of a die 1 is shown in FIG. 3, only seen in the front view and thus not in plan view. The die 1 is designed as a cylindrical body, which is arranged coaxially to the roller 5. It has four blades 6 on its circumference. It is rotatably mounted. During operation, the cylindrical body stands still. After a certain operating time and thus after a certain wear it can be rotated around its own axis, so that another one of the four blades comes into working position, thus lying opposite the vertex of the roller 5.

The cylindrical body 1 can be solid. In this case, it has bores 7 extending from the blade region to a central bore 7.3, which in turn is followed by a suction mechanism, that is, by the chip discharge device 13, that is only schematically indicated in FIG. 1.

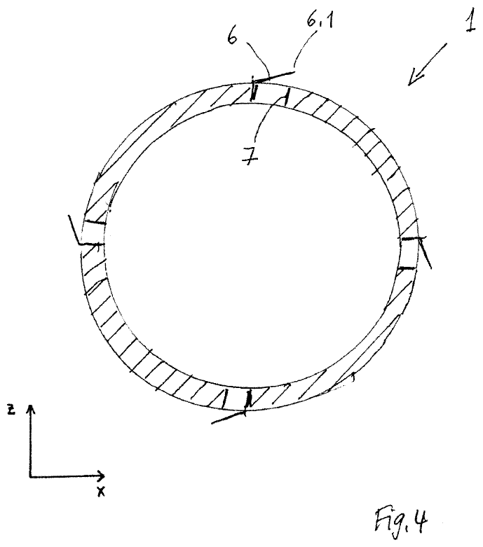

The cylindrical body 1 can also be hollow, see FIG. 4. The mantle of the cylindrical body 1 in turn has bores 7 in the area of the blades 6, through which the chips of the removed layer material fall into the interior of the cylindrical body 1. At least one front face of the cylindrical body 1 is open so that the chips can pass from the inside to the outside. For this reason, this variant does not require a suction device.

The advantages of the device according to the invention can be summarized as follows:
The device allows to remove the coating from a coated metal plate, in particular a zinc-coated sheet metal board. The coating can be removed at any point of the work piece. The coating-free surface can be of any shape and size, e.g. striped, round or square.
Thickness tolerances of the starting material, i.e. of the uncoated sheet metal, are compensated by the flexible roller, which is part of the punch.
The device can be used for any type of flat sheet metals. All contours and positions are freely programmable.
The device is simple in construction, and uncomplicated and reliable in operation. The removed chips accumulate in a very localized area and are reliably extracted by suction so that they do not get into the environment and contaminate it.
The area-related evaporation of the zinc with all its disadvantages is avoided, and downstream laser welding can be carried out with high process reliability. The investment costs for the tool are very low.

1. A device for partially removing the coating of a metal plate, the device comprising the following features:
a die and a punch which together form a gap through which the metal plate is fed;
a drive for generating a relative movement between the die and the metal plate and between the punch and the metal plate;
the die having a projecting blade on its surface facing the metal plate, a cutting edge of said blade extending in a direction opposite to the movement direction of the metal plate;
a rotary drive for rotating the die and the punch in a direction of the cutting edge;
a pressing device for pressing together the die and the punch;
the punch having a roller which rolls on the metal plate surface opposite the blade.

2. The device according to claim 1, wherein the die and the punch are stationary and can be rotated around a common axis.

3. The device according to claim 1, wherein the roller is elastically supported or consists of an elastic material such as hard rubber.

4. The device according to claim 1, wherein the die has a convexly curved upper contact surface.

5. The device according to claim 4, wherein the die is a cylindrical body arranged coaxially to the roller.

6. The device according to claim 5, wherein the die is a hollow cylinder.

7. The device according to claim 1, wherein the die has a bore for chip discharge, the inlet of which is located in the region of the blade and the outlet of which is connected to a chip discharge device.
